(19) United States
(12) Patent Application Publication
(10) Pub. No.: US 2026/0189278 A1
(43) Pub. Date: Jul. 2, 2026

(54) COORDINATED BEAMFORMING AND SPECIAL REUSE IN NETWORKS WITH ULTRA HIGH RELIABILITY INFORMATION EXCHANGE BETWEEN ACCESS POINTS

(71) Applicant: Intel Corporation, Santa Clara, CA (US)

(72) Inventors: Qinghua Li, San Ramon, CA (US); Po-Kai Huang, San Ramon, CA (US); Juan Fang, Portland, OR (US); Dibakar Das, Hillsboro, OR (US); Dmitry Akhmetov, Hillsboro, OR (US); Laurent Cariou, Milizac (FR); Danny Alexander, Neve Efraim Monoson (IL); Shlomi Vituri, Tel Aviv (IL)

(21) Appl. No.: 19/545,544

(22) Filed: Feb. 20, 2026

Related U.S. Application Data
(60) Provisional application No. 63/760,952, filed on Feb. 20, 2025.
(60) Provisional application No. 63/767,790, filed on Mar. 6, 2025.

(51) Int. Cl. H04B 7/06; H04L 69/323

(52) U.S. Cl. CPC H04B 7/0617; H04L 69/323

(57) ABSTRACT

This disclosure describes systems, methods, and devices related to optimized beamforming exchange. A device may transmit a coordinated beamforming (Co-BF) invite frame comprising a first Ack Sequence Duration. The device may receive from a coordinated AP a Co-BF response frame comprising a Co-BF status code and a second Ack Sequence Duration. The device may transmit a data PPDU comprising MPDUs having an Ack policy set to either HETP Ack or Block Ack based on the Co-BF Response frame. The device may perform a sequential acknowledgment procedure first to solicit receiving status of MSDUs or A-MSDUs from recipient non-AP STAs based on the data PPDU.

### CROSS-REFERENCE TO RELATED APPLICATION(S)

This application claims the benefit of U.S. Provisional Application No. 63/760,952, filed Feb. 20, 2025, and U.S. Provisional Application No. 63/767,790, filed Mar. 6, 2025, the disclosures of which are incorporated herein by reference as if set forth in full.

### BACKGROUND

Wireless devices are becoming more prevalent, necessitating efficient access to wireless channels. Standards are evolving to enhance connectivity, integrating advanced technologies in modern networks.

### BRIEF DESCRIPTION OF THE DRAWINGS

FIG. 1 is a network diagram illustrating an example network environment for optimized beamforming exchange, in accordance with one or more example embodiments of the present disclosure.

FIGS. 2-5 depict illustrative schematic diagrams for optimized beamforming exchange, in accordance with one or more example embodiments of the present disclosure.

FIGS. 6-10 depict illustrative schematic diagrams for optimized beamforming exchange, in accordance with one or more example embodiments of the present disclosure.

FIG. 11 illustrates a flow of a process for an illustrative optimized beamforming exchange system, in accordance with one or more example embodiments of the present disclosure.

FIG. 12 illustrates a functional diagram of an exemplary communication station that may be suitable for use as a user device, in accordance with one or more example embodiments of the present disclosure.

FIG. 13 illustrates a block diagram of an example machine upon which any of one or more techniques (e.g., methods) may be performed, in accordance with one or more example embodiments of the present disclosure.

FIG. 14 is a block diagram of a radio architecture in accordance with some examples.

FIG. 15 illustrates an example front-end module circuitry for use in the radio architecture of FIG. 14, in accordance with one or more example embodiments of the present disclosure.

FIG. 16 illustrates an example radio IC circuitry for use in the radio architecture of FIG. 14, in accordance with one or more example embodiments of the present disclosure.

FIG. 17 illustrates an example baseband processing circuitry for use in the radio architecture of FIG. 14, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

Coordinated beamforming (CBF) and coordinated spatial reuse (CSR) are two features in IEEE 802.11bn, i.e., Wi-Fi 8. Because it involves two APs to send data simultaneously over the same frequency channel, information needs to be exchanged among the APs over a sequence of MAC frames. Essential information required in the exchange are listed and frame formats for carrying the information are proposed.

In a coordinated beamforming (Co-BF) communication system, a coordinating access point (AP) refers to an access point that assumes primary control responsibility for initiating, managing, and sequencing a coordinated transmission operation involving at least one additional access point. The coordinating AP initiates coordination by transmitting an invitation to participate in a coordinated transmission and, upon acceptance, controls the timing and procedural flow of the operation. In particular, the coordinating AP determines when coordinated data transmissions occur, signals acknowledgment-related timing parameters, and leads post-transmission control procedures. Following simultaneous transmission of data units by multiple access points, the coordinating AP performs acknowledgment processing prior to any participating access point and is configured with flexibility in selecting an acknowledgment policy for transmitted data units, thereby establishing the coordinating AP as the control-plane leader for the coordinated transmission session.

A coordinated access point (AP) refers to an access point that participates in the coordinated beamforming operation under the control of the coordinating AP. The coordinated AP receives the coordination invitation and selectively accepts or rejects participation, and, upon acceptance, provides operational parameters necessary to align its transmission behavior with that of the coordinating AP. During the coordinated transmission, the coordinated AP transmits data substantially simultaneously with the coordinating AP but follows a constrained control role thereafter. Specifically, the coordinated AP defers acknowledgment sequencing to the coordinating AP, configures its transmitted data units to use a restricted acknowledgment policy, and supplies timing information used by the coordinating AP to manage post-transmission acknowledgment procedures. In this manner, the coordinated AP contributes transmission resources and channel participation while adhering to a control sequence dictated by the coordinating AP, resulting in an asymmetric but cooperative access point relationship.

Some ideas about the information exchanges in the preparation/initialization phase of CBF were proposed. The acknowledgment phase was not discussed.

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

The channel sounding and feedback of coordinated beamforming (CBF) are unreliable because there is no acknowledgement for the sounding feedback. Each AP of a CBF group doesn't know what beamforming vectors and nulling vectors the other AP has. Without the information, the user grouping of CBF can't be done properly. Information exchange is needed between the APs.

Before the sounding/feedback for CBF, the two APs may also need to do frame exchange. Firstly, the initiating AP may want to check the availability of the responding AP and increase the reception capability of responding AP. In addition, the two APs may tell each other their storage sizes so that the number of CBF users of each AP can be managed without causing storage overflow. For each scheduled STA, the associated AP needs to store the beamforming vectors pointing to the STA, and the OBSS AP needs to store the nulling vectors that generate nulls pointing to the STA. If one AP schedules too many STAs, there will be not enough storage space left for the other AP to schedule its STAs.

Example embodiments of the present disclosure relate to systems, methods, and devices for Frame Exchange for Wi-Fi 8 CBF and CSR.

In one embodiment, an optimized beamforming exchange system may facilitate additional details are provided for the preparation/initialization phase of CBF. Details about the acknowledgement phase are provided.

In one or more embodiments, an optimized beamforming exchange system may enable CBF and CSR features in Wi-Fi 8 so that the throughput of devices may be improved.

Example embodiments of the present disclosure relate to systems, methods, and devices for Information Exchange between APs for UHR Coordinated Beamforming.

After the sounding and feedback of CBF, AP 1 may tell AP 2 which STA of AP 2 AP1 has the nulling vectors. Alternatively, the two APs may not exchange the availability of the nulling vectors right after the sounding and feedback. Instead, in the CBF response frame of the CBF initialization phase, the shared AP may tell the sharing AP which scheduled STA of the sharing AP the shared AP does not have the nulling vectors.

Before the CBF sounding/feedback, the two APs may exchange the number of scheduled users and the storage capacity in addition to the availability check and capability wake up. This will improve the performance of the CBF to enhance the user experience on laptops.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

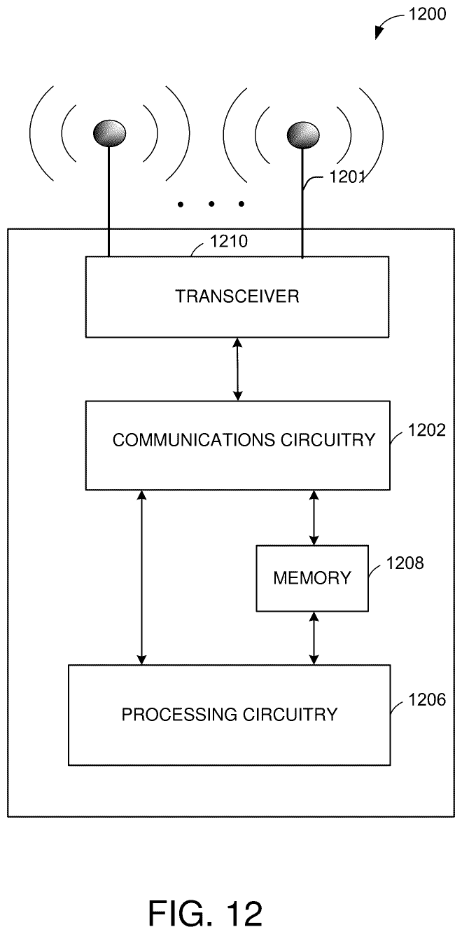

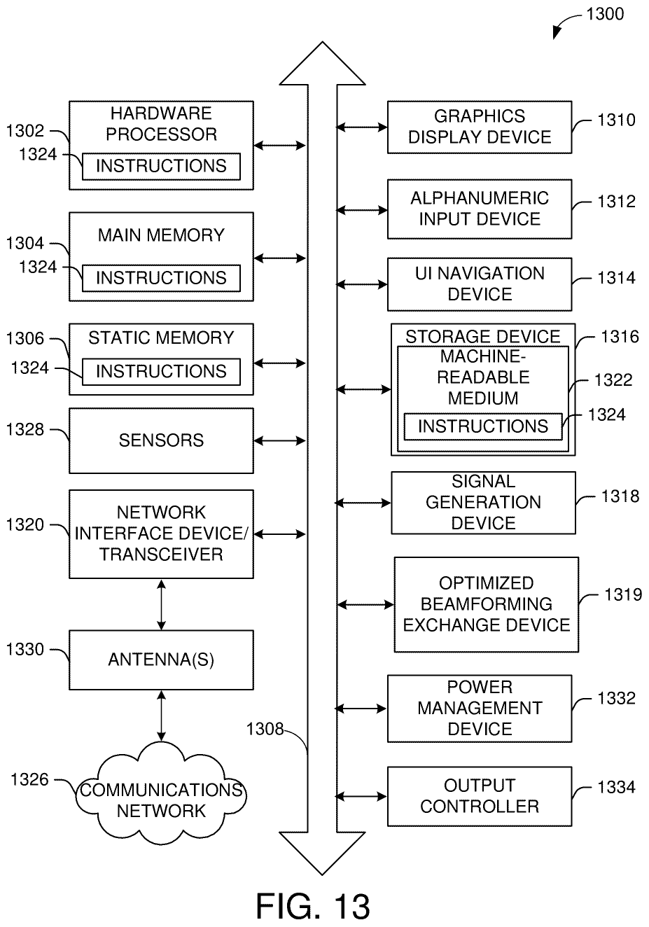

In some embodiments, the user devices 120 and the AP 102 may include one or more computer systems similar to that of the functional diagram of FIG. 12 and/or the example machine/system of FIG. 13.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

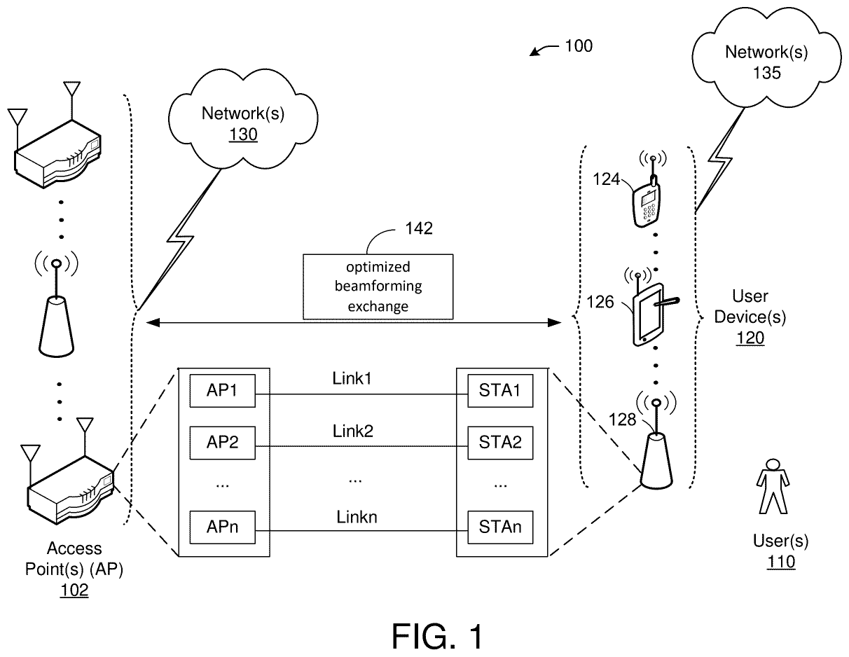

In one embodiment, and with reference to FIG. 1, a user device 120 may be in communication with one or more APs 102. For example, one or more APs 102 may implement an optimized beamforming exchange 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, ..., APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

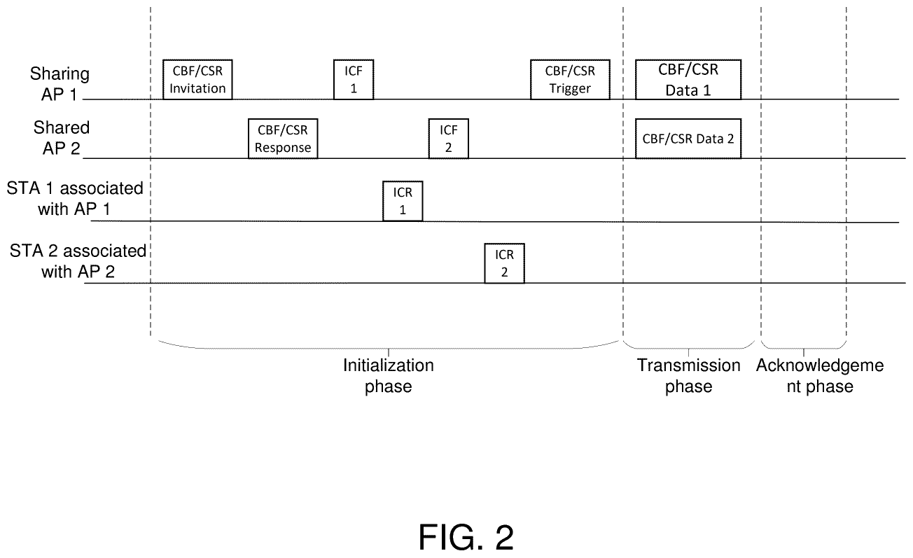

FIGS. 2-5 depict illustrative schematic diagrams for optimized beamforming exchange, in accordance with one or more example embodiments of the present disclosure.

A unified exchange sequence is shown in FIG. 2 for CBF and CSR. There are three phases: initialization (or preparation) phase, transmission phase, and acknowledgement phase. The previous disclosures focused on the initialization phase. The following ideas are added for the initialization phase.

Additional Design for Initialization Phase:

The sharing AP may allocate a certain number of spatial streams to the shared AP. The stream allocation may be in a user info field in the CBF invitation. The AID of the user info field has the AID that is allocated to the shared AP by the sharing AP. The stream allocation may be indicated by the spatial stream allocation (SS Allocation) subfield in the user info field. The shared AP can assign all or part of the allocated streams to its STA(s). The CBF invitation may be unicast with the shared AP's MAC address as the receiver address (RA). If the sharing AP wants to invite the shared AP for multiple CBF/CSR transmissions, the subfield of more trigger frame (More TF), which is in a common info field of CBF/CSR trigger and/or CBF/CSR invitation, may be used to indicate whether there is a subsequent trigger or invitation.

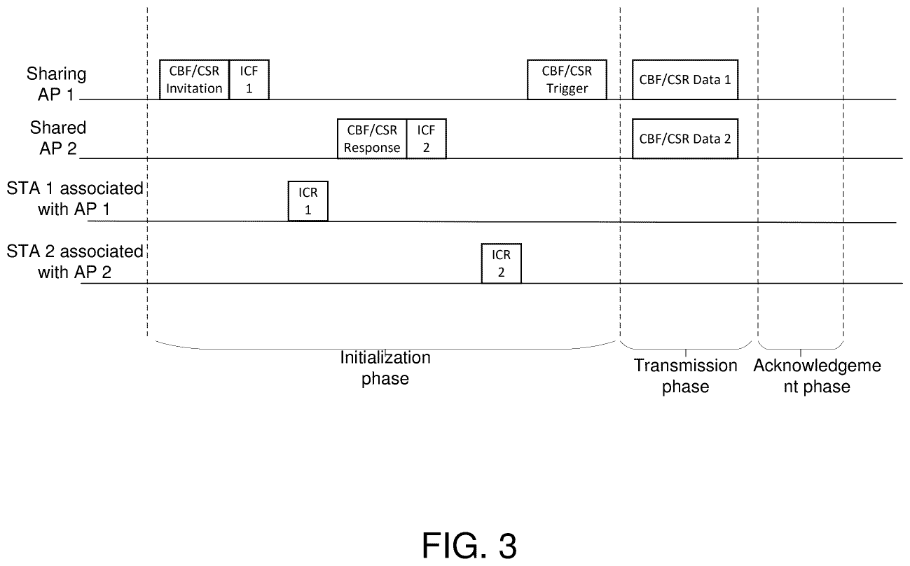

The design in FIG. 2 assumes that AP does not send trigger-based PPDU. This is an agreement by most companies. There are seven frames in the initialization phase in FIG. 2. To reduce the overhead, an alternative is proposed in FIG. 3. In the first frame on the left, the sharing AP sends an CBF/CSR invitation to the shared AP and an ICF to the scheduled STAs of the sharing AP. In the second frame(s) on the left, one or more STAs send the ICRs to the sharing AP in response to the preceding ICF. The shared AP may not send an ICR frame together with the sharing AP's STAs. The reason is that the ICRs are sent in trigger-based PPDU format, and the shared AP usually doesn't support this PPDU format. In the third frame on the left, the shared AP sends CBF/CSR response to the sharing AP and an ICF to the scheduled STA(s) of the shared AP. In the fourth frame(s) on the left, one or more STAs send the ICRs to the shared AP in response to the preceding ICF. The sharing AP may not send an ICR frame together with the shared AP's STAs. The reason is that the ICRs are sent in trigger-based (TB) PPDU format and the sharing AP usually doesn't support this PPDU format. If the sharing or shared AP supports TB PPDU transmission, the AP may be addressed by the preceding ICF and may send an ICR together with the addressed STAs of the other AP.

In FIG. 3, the first frame on the left carries the information for both CBF/CSR invitation and ICF. The information can be carried in one MAC frame, i.e., a trigger frame like BSRP. If so, the user info field with the shared AP's AID carries the information for the shared AP. Special user info field and trigger dependent common/user info field can be used to carry information for the shared AP as well. The information for the shared AP includes the stream allocations of the sharing AP's selected STAs. The stream allocations are for the downlink data PPDU transmission. The AIDs of the sharing AP's selected STAs corresponding to stream allocations can be found sequentially in the AID subfields of the STAs'user info fields that carry the information for ICF, e.g., the resource allocations for the uplink ICR transmissions. Or, the information in the first frame on the left can be carried by two MAC frames using A-MPDU format, where one MPDU is for CBF/CSR invitation and the other is for ICF. STA checks the RA of the MPDU. If the RA is neither the STA's address nor broadcast address, the STA may drop the whole PPDU. Therefore, it is desired that the MPDU of ICF, whose RA is the scheduled STA's address or broadcast address, goes first followed by the MPDU of the CBF/CSR invitation, whose RA may be the shared AP's address. Similarly, the third frame on the left carries the information for CBF/CSR response and ICF. The information can be carried in one MAC frame, i.e., a trigger frame like BSRP or an acknowledgement frame like Multi-STA BlockAck. Or, the information can be carried in two MAC frames using A-MPDU format, where one MPDU is for CBF/CSR response and the other is for ICF. It is desired that the MPDU of ICF, whose RA is the scheduled STA's address or broadcast address, goes first followed by the MPDU of the CBF/CSR response, whose RA may be the sharing AP's address. The frame format of CBF/CSR response may be a trigger frame like BSRP or an acknowledgment frame like Multi-STA BlockAck. The CBF/CSR trigger may be called CBF/CSR synch. It may be a trigger frame like BSRP. Two sets of resource allocations need to be determined and specified in CBF/CSR trigger, (and/or CBF/CSR invitation, and/or CBF/CSR response). One set of resource allocation is for the downlink CBF data transmission and the other is for uplink Ack/BA transmission. The resource allocation of the Ack/BA is described next.

### Design for Acknowledgement Phase:

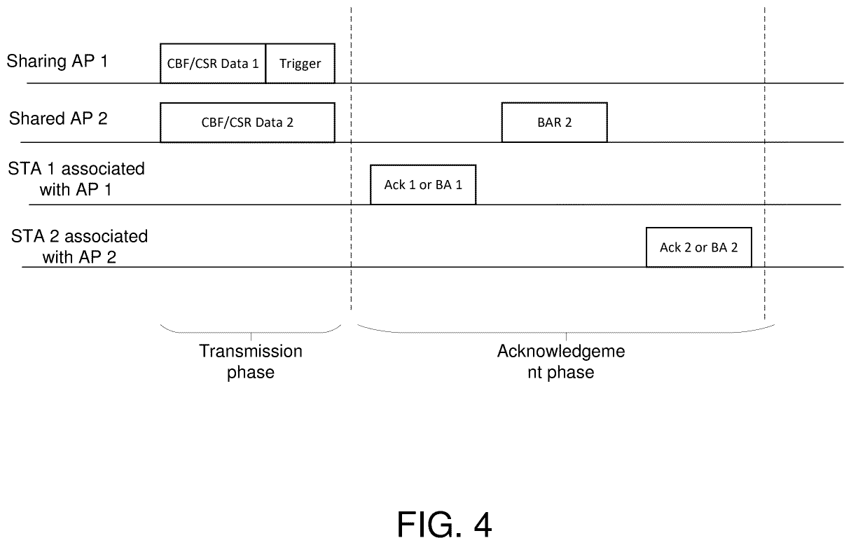

There are three options for the acknowledgement transmission, TDMA, OFDMA, and SDMA. The TDMA scheme is shown in FIG. 4. The CBF Data PPDU of sharing AP (or shared AP) can include a trigger frame for soliciting BA or Ack from the addressed STA(s). The Ack Policy Indicator subfield in the QoS control field of the data frame can be set to 01, HE-Type-PPDU (HETP) Ack. The other AP, e.g., the shared AP, can set the Ack Policy Indicator subfield in the QoS control field of the data frame can be set to 11, Block Ack. The 802.11 specification (“spec”) may mandate that the sharing AP and shared AP use HETP Ack and Block Ack, respectively. As shown in FIG. 4, the AP, which appends a trigger to the data frame, receives the Ack or BA first, and then the other AP sends a BAR to solicit its Ack or BA. The duration of the earlier Ack or BA transmission needs to be known by the other AP. The duration can be specified in the CBF/CSR invitation, CBF/CSR trigger, and CBF/CSR response in the initialization phase. The BAR should be sent SIFS after the termination of the earlier Ack or BA. The total transmission bandwidth of the Ack, BA, and BAR should be the same as the CBF/CSR data PPDU for holding the channel. For the subsequent transmission, the sharing AP may listen to the BAR sent by the shared AP to determine the end time of the shared AP's Ack/BA. The duration of the Ack/BA is indicated in the BAR. As an alternative, sharing AP may indicate the total or individual duration of the BAR and Ack/BA of the shared AP in the CBF/CSR trigger or CBF/CSR invitation. The next transmission of the sharing AP should be SIFS after the termination of the shared AP's Ack/BA.

As used herein, the term HETP refers to a High Efficiency Physical Layer Convergence Procedure (PLCP) Protocol Data Unit as defined by the IEEE 802.11ax standard and its derivatives. An HETP Ack policy specifies a communication protocol wherein an acknowledgment frame, such as a BlockAck or Multi-STA BlockAck, is encapsulated within an HE-compliant physical layer header for transmission. This format supports advanced features of High Efficiency (HE) operation, including but not limited to, Orthogonal Frequency Division Multiple Access (OFDMA) and spatial multiplexing. When the Ack policy is set to HETP, the Ack Sequence Duration is calculated based on the temporal length of the HE-formatted response frame, facilitating precise Network Allocation Vector (NAV) setting and medium synchronization between an Access Point (AP) and one or more non-AP STAs in a dense wireless environment.

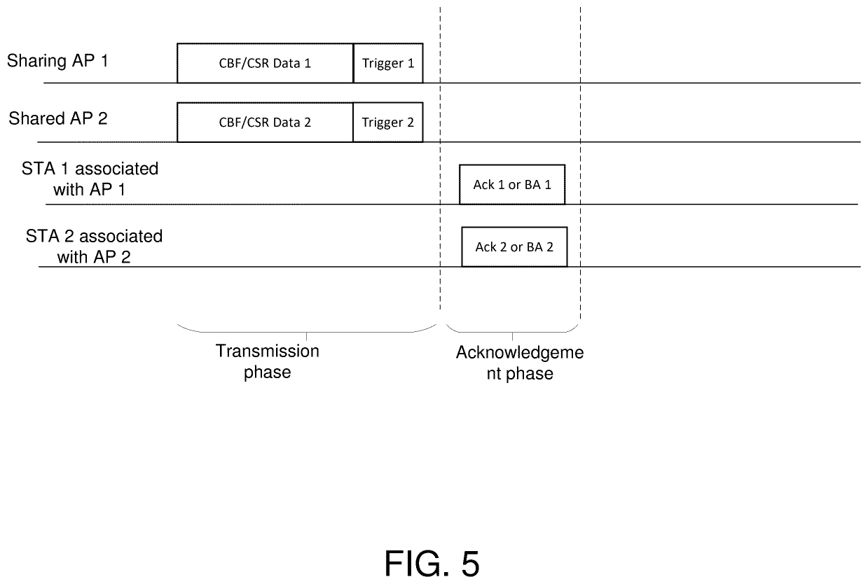

The OFDMA and SDMA schemes are shown in FIG. 5. Trigger frames are aggregated with the CBF data frames. The trigger frames solicit Acks and BAs from the addressed STAs. In addition, the trigger frames allocate resources for the uplink transmissions of the Acks and BAs. The resources can be in frequency domain or spatial domain. In frequency domain, RUs are allocated to different STAs, respectively. The RU allocations for the uplink Ack/BA can be specified in the CBF/CSR trigger, (or CBF/CSR invitation, or CBF/CSR response). In the initialization phase, each AP may just need to get one large RU. The large RU will be divided into small RUs and the trigger frame, which is aggregated with the data frame, allocates the small RUs are to the scheduled STAs for their uplink Ack/BA transmissions, respectively. As an alternative, in the CBF/CSR trigger, the RA allocation subfield in the user info field, whose AID is the scheduled STA's AID, may allocate the RU for the STA's uplink Ack/BA transmission.

In spatial domain, spatial streams are allocated to different STAs, respectively. The stream allocation of data PPDU can be the same as the stream allocation for the Ack/BA PPDU transmissions. If so, the resource allocation overhead, which allocates resources to data transmission and BA transmission in the CBF/CSR trigger, (or CBF/CSR invitation, or CBF/CSR response), can be reduced roughly by half. Namely, the CBF/CSR trigger assigns the same spatial stream(s) for both the data transmission(s) and the corresponding Ack/BA transmission(s). The trigger frames, which are aggregated with the data frames, just follow the allocations in the CBF trigger in assigning resources to each STA for the STA's Ack/BA transmission, respectively. For SDMA, i.e., uplink MU-MIMO, because the uplink transmission only has one BSS color subfield in the uplink PPDU preamble, the BSS color needs to be set to the same value by all STAs that send Acks/BAs simultaneously in the same subchannel. The BSS color can be set to the one of the sharing AP or shared AP. For OFDMA, different subchannels may be allocated to different STAs, respectively. Different STAs may set the BSS colors according to their APs'BSS colors, respectively. However, if the channel only has one subchannel, in which case the total bandwidth is 20 MHz, all the STAs need to set the BSS color in the uplink Ack/BA transmissions to the same value. The transmission mode of the Ack/BA, i.e., TDMA, OFDMA, or SDMA, needs to be specified in the CBF/CSR invitation, or CBF/CSR trigger, or CBR/CSR response. The value of the BSS color in the preamble of Ack/BA PPDU may be explicitly specified in the CBF/CSR trigger, (or CBF/CSR invitation, or CBR/CSR response) or implicitly defined by the spec, e.g., the BSS color of the sharing AP.

For both CBF and CSR, it is desired that the downlink data and uplink Ack/BA of the sharing and shared APs start and end the simultaneously for holding the channel and controlling the OBSS interference. Therefore, the duration of the uplink Ack/BA PPDU transmission needs to be specified in the CBF/CSR trigger, (or CBF/CSR invitation, or CBF/CSR response). Similarly, the duration of the down data PPDU transmission needs to be specified in the CBF/CSR trigger, (or CBF/CSR invitation, or CBF/CSR response). Because of the large difference of path losses, for CSR, the same stream or same RU can be assigned to different STAs of different APs for the downlink and uplink transmissions, respectively.

It is understood that the above descriptions are for the purposes of illustration and are not meant to be limiting.

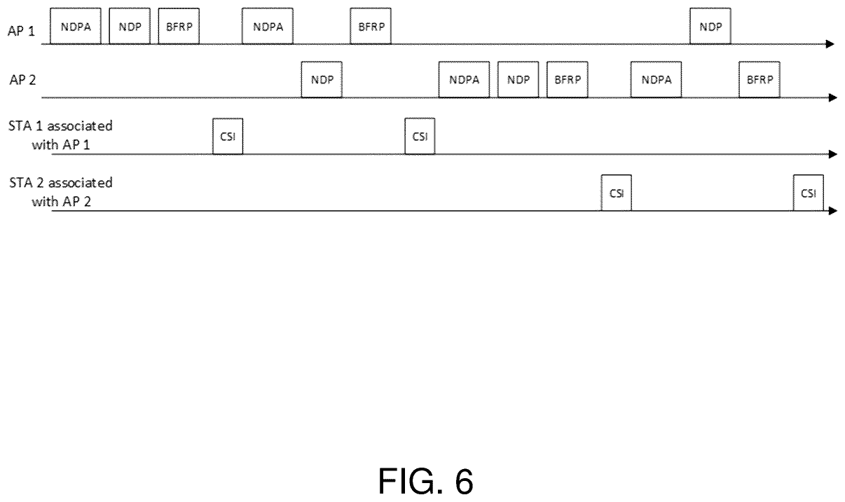

FIGS. 6-10 depict illustrative schematic diagrams for optimized beamforming exchange, in accordance with one or more example embodiments of the present disclosure.

In one or more embodiments, an optimized beamforming exchange system may facilitate:

### 1. Unreliable Sounding Feedback:

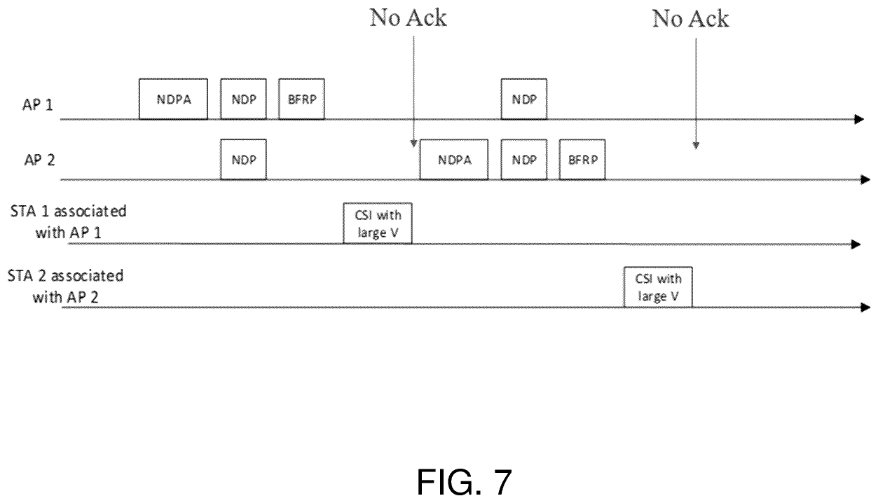

The sounding and feedback schemes for CBF are shown in FIGS. 6 and 7, which are for the mandatory sequential sounding and the optional joint sounding, respectively. In the sequential sounding of FIG. 6, the second CSI feedback of STA 1 is for AP 2. The channel state information (CSI) carries beamforming and/or nulling vectors in FIGS. 6 and 7. If AP 2 doesn't receive the feedback, AP 2 can't send a BFRP for asking STA 1 to resend the CSI feedback. The reasons are that there is no acknowledgement for the CSI feedback and the BFRP is always sent by the AP with which the feedback STA is associated. Similarly, in the joint sounding of FIG. 7, the first Large V based feedback may not be received by AP 2. In this case, AP 2 can't send a BFRP to ask STA 1 to resend the CSI feedback. As a result, after the sounding and feedback, each AP doesn't know which CSI feedback the other AP correctly received. Similar problem occurs in FIG. 7 for joint sounding and feedback.

FIG. 6 shows a sequential sounding of CBF.

In FIG. 7, if AP 2 does not receive the first NDPA, AP 2 does not send the first NDP. In this case, STA 1 doesn't know the NDP is not sent and uses noise to generate the first CSI report, CSI with large V. This also makes the CSI report unreliable. Fortunately, if AP 2 doesn't receive the first NDPA, AP 2 does not listen to the BFRP and the first CSI report. Therefore, the problem can be solved if AP 2 tells AP 1 that AP 2 doesn't have the nulling vectors for STA 1. It is proposed that the Channel State Information (CSI) status be exchanged by the access points (APs) after sounding and feedback to address this issue.

FIG. 7 shows a joint sounding of CBF.

### 2. Limited Storage:

Each AP has a limited storage capacity to store the beamforming and nulling vectors. If AP 1 schedules too many users for the sounding and feedback, the CSI reports sent by the STAs of AP 1 may use up the storage of the AP 2 such that AP 2 doesn't have enough storage capacity left for AP 2's to store the beamforming and/or nulling vectors for scheduling its STAs.

### Solutions to Unreliable Sounding Feedback:

Solution 1—CSI Status Feedback during User Selection before Data Transmission:

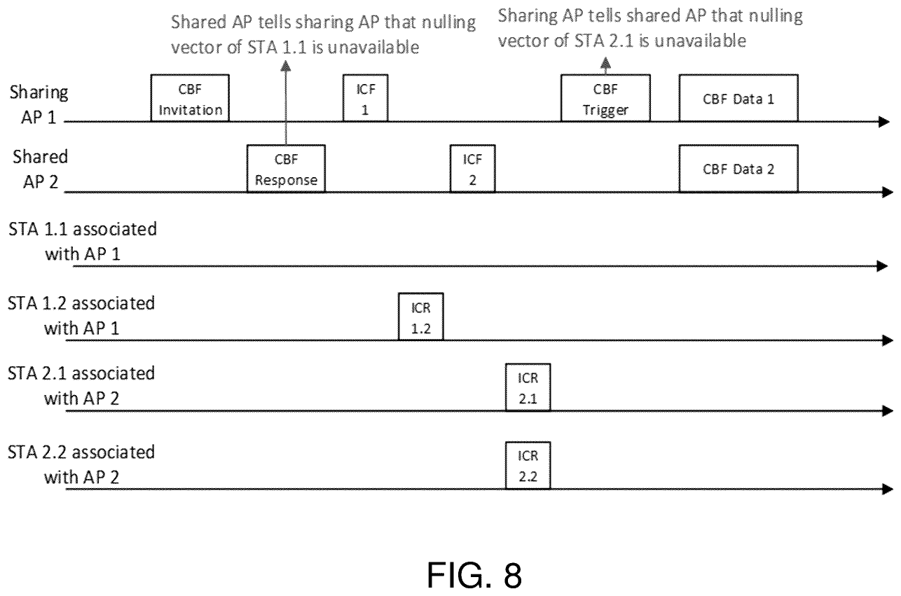

The idea is illustrated in FIG. 8. Within the scheduling exchange right before the actual CBF data transmission, there are multiple frame exchanges between the two APs. The CSI availability of each AP can be sent to the other AP. For example, it is assumed that AP 1 and AP 2 select their STAs for the CBF transmission independently. AP 1 selects STA 1.1 and STA 1.2 and indicates the selection in the CBF invitation, which is sent to AP 2. AP 2 realizes that the nulling vectors for STA 1.1 is unavailable, e.g., in its storage. In CBF response, AP 2 tells AP 1 that STA 1.1 can't be supported in the CBF transmission. In ICF 1, STA 1.1 is dropped, and AP 1 doesn't send the ICF to STA 1.1. Also, in the CBF response, AP 2 tells AP 1 that AP 2 selects STA 2.1 and STA 2.2 for the data transmission. In CBF trigger, AP 1 tells AP 2 that the nulling vectors for STA 2.1 is unavailable. Also, in CBF trigger, the STAs finally selected for the data transmission, which are STA 1.2 and STA 2.2, are listed. One AP's indication of the CSI unavailability of an OBSS STA prevents the other AP from persistently scheduling that STA.

There are multiple frame exchanges from CBF invitation to CBF trigger. There are multiple ways for the APs to exchange the CSI status. The CSI status information can be sent in ICF and ICR as well.

Solution 2—CSI Status after Sounding Feedback:

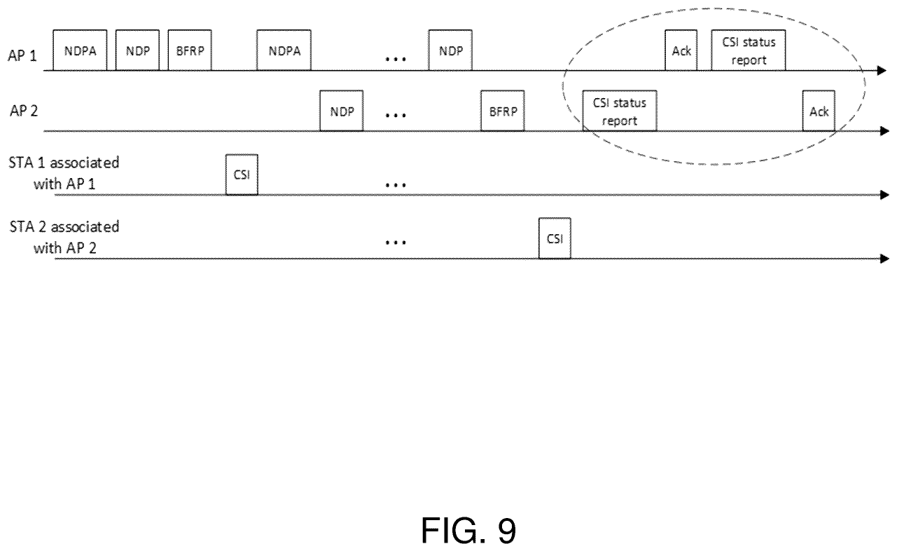

The idea is illustrated in FIG. 9. After the sounding and feedback processes illustrated in FIGS. 6 and 7, APs can exchange CSI status. For example, AP 1 sends a CSI status report to AP 2. In the report, AP 1 tells AP 2 the nulling vectors of which AP 2's STAs are available at AP 1. The CSI status exchange may occur after SIFS of the last CSI report in the sounding and feedback process. Or, the CSI status exchange can occur any time after the sounding and feedback process and before the CBF data transmission. The CSI status report can be sent by a management frame. Acknowledgement may be sent for confirming the receipt of the CSI status report.

In FIG. 9, AP 2 sends the CSI status report before AP 1's because AP 2 finishes its CSI report reception before AP 1 and AP 1 may need some time to generate the CSI status report.

### Solution 3—Retransmission of CSI Report:

The CSI report is sent by action-no-Ack frame. There is no acknowledgement for the receipt. The 802.11 specification (“spec”) may define acknowledgement procedure for the CSI report. Or, the spec may define a frame exchange between the APs. The frame exchange enables that AP 1 asks AP 2 to send BFRP to AP 2's STA so that the STA retransmit the CSI report to AP 1.

### Solutions to Limited Storage Capacity:

Solution 1—Capacity Exchange before Sounding and Feedback:

Before the sounding and feedback process illustrated in FIGS. 6 and 7, the APs need to select the STAs to be sounded and to send the CSI reports. The more STAs the larger storage space is required to store the CSI reports. During the CBF negotiation between the APs, each AP may specify its storage capacity for CBF. For example, each AP may indicate for how many OBSS STAs it can store their nulling vectors, i.e., the maximum number of CBF OBSS STAs the AP can support. The nulling vectors are in the CSI report. For joint sounding, the CSI report carries two sets of vectors, one for the intra-BSS AP's beamforming and the other for the inter-BSS AP's nulling. The OBSS AP only needs to store the vectors that generate nulls pointing to the reporting STA. The intra-BSS AP only needs to store the vectors that generate beams pointing to the reporting STA.

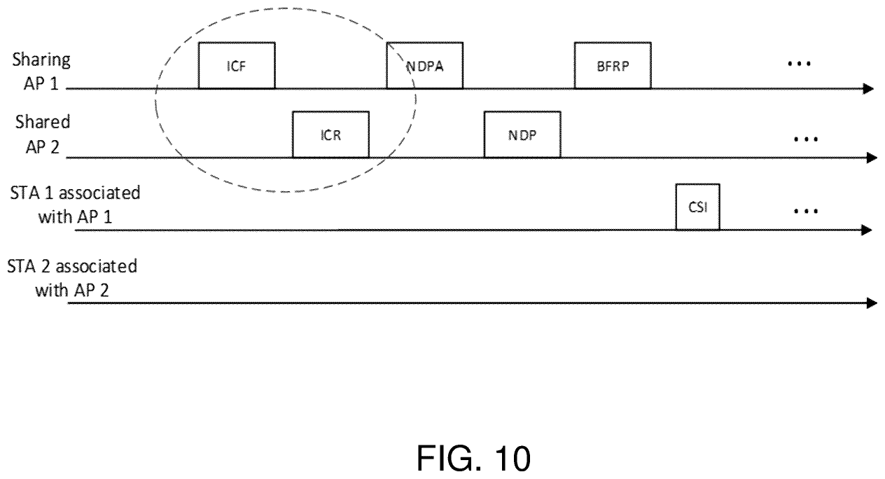

Before the sounding, each AP selects its STAs, which will send the CSI reports. The total number of selected STAs within a certain time interval should not be greater than that the other AP can support. The time interval, e.g., 20-30 milliseconds, is related to the channel coherence time. The channel is assumed to be unchanged during the time interval. The (beamforming and/or nulling) vectors reported within the time interval are valid. Vectors stored longer than the time interval are outdated or invalid. Invalid vectors may be deleted to free space for new vectors. The time interval may be exchanged or specified during the CBF negotiation between the APs. Or, the time interval may be defined in the spec. Before each CBF sounding and feedback process, which is illustrated in FIGS. 5 and 6, each AP may specify how many OBSS STAs it can handle for the coming sounding and feedback process. An example is illustrated in FIG. 10. AP 1 sends a frame, e.g., ICF, to wake up and invite AP 2 for a cross-BSS sounding. In the invitation frame, the number of AP 2's STAs, which AP 1 can store their nulling vectors, is specified. Similarly, in the response frame, e.g., ICR, AP 2 indicates the number of AP 1's STAs, which AP 2 can store their nulling vectors. The ICF and ICR can be replaced by other control frames or management frames like those in FIG. 9, where the two APs send management frames and acknowledgements. Besides the storage capacity information, CSI status information can be exchanged (together with the storage capacity information) before the sounding and feedback process.

In addition to the capacity exchange, the MCS by which the CSI report is sent may be exchanged between the APs (together with the storage capacity information). For example, AP 1 may tell AP 2 which MCS should be used for AP 2's STA to send the CSI report to AP 1. The suggested MCS may be specified in the BFRP sent by AP 2 to AP 2's STA for cross BSS sounding and feedback.

It is understood that the above descriptions are for the purposes of illustration and are not meant to be limiting.

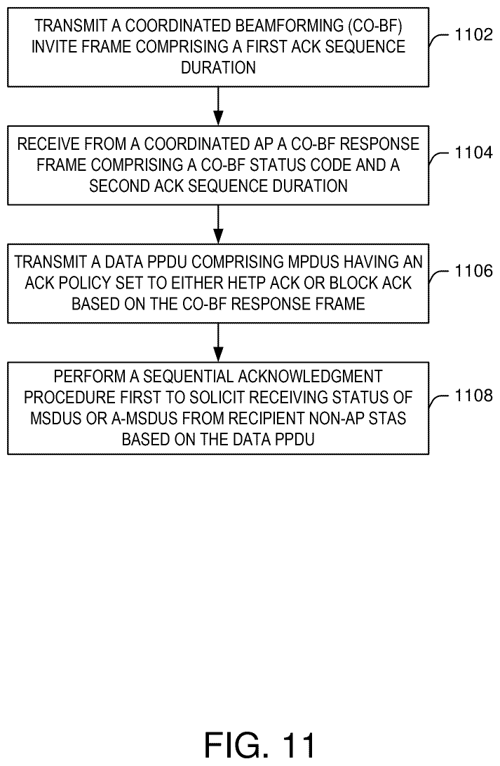

FIG. 11 illustrates a flow of illustrative process 1100 for an optimized beamforming exchange system, in accordance with one or more example embodiments of the present disclosure.

At block 1102, a device (e.g., the user device(s) 120 and/or the AP 102 of FIG. 1 and/or the optimized beamforming exchange device 1319 of FIG. 13) may transmit a coordinated beamforming (Co-BF) invite frame comprising a first Ack Sequence Duration.

At block 1104, the device may receive from a coordinated AP a Co-BF response frame comprising a Co-BF status code and a second Ack Sequence Duration.

At block 1106, the device may transmit a data PPDU comprising MPDUs having an Ack policy set to either HETP Ack or Block Ack based on the Co-BF Response frame.

At block 1108, the device may perform a sequential acknowledgment procedure first to solicit receiving status of MSDUs or A-MSDUs from recipient non-AP STAs based on the data PPDU.

In one or more embodiments, a device or a system may determine whether a Co-BF Status Code indicates a successful outcome. This functionality is designed to ensure that the device can reliably interpret status signals and proceed with coordinated operations when the appropriate conditions are met. For example, when the device receives a SUCCESS indication, it may initiate further data exchange processes, thereby addressing the need for robust communication in coordinated wireless environments.

In scenarios where the Co-BF Status Code signals a rejection with an unspecified reason, the device or system may recognize this outcome and decide to forego transmitting the data PPDU. This approach offers a solution to unnecessary resource expenditure and prevents futile transmission attempts. As an example, upon detecting REJECTED_REASON_UNSPECIFIED, the device may halt its planned data transmission, maintaining network efficiency and avoiding collisions.

A device or system may also be configured to set its acknowledgment policy to HETP Ack, providing operational flexibility in acknowledgment handling. This choice allows the device to adapt its behavior based on real-time feedback and changing network conditions. For instance, the device may opt for HETP Ack to optimize throughput and reduce latency during high-traffic periods.

To ensure interoperability and compliance with communication standards, the device or system may transmit a Co-BF Trigger frame using formats such as non-HT PPDU or non-HT duplicate PPDU, and select transmission rates of 6 Mb/s, 12 Mb/s, or 24 Mb/s. This capability addresses the challenge of supporting diverse device types and legacy protocols. For example, the device may send a trigger frame at 12 Mb/s in a non-HT PPDU format to accommodate older network nodes.

Synchronization is further enhanced as the device or system may compare the first Ack Sequence Duration in the Co-BF Invite frame with the second Ack Sequence Duration in the Co-BF Response frame. This comparison ensures that both parties are aligned in their expectations for acknowledgment timing, reducing the risk of miscommunication. For example, the device may adjust its operation if the durations differ, promoting seamless coordination.

Addressing logic is critical in coordinated exchanges. In one or more embodiments, the device or system may use the MAC address of the coordinated AP as the receiver address in the Co-BF Invite frame, and the MAC address of the coordinating AP as the receiver address in the Co-BF Response frame. This approach solves the problem of ambiguous addressing and streamlines targeted communication. For example, the device may direct its invite to a specific AP by including its MAC address in the frame.

To further improve communication efficiency, the device or system may specify the MAC frame type of the Co-BF response frame as Multi-STA BlockAck. This configuration enables acknowledgment of multiple stations in a single frame, reducing overhead and improving throughput. For example, the device may employ Multi-STA BlockAck to confirm receipt from multiple devices simultaneously.

It is understood that the above descriptions are for the purposes of illustration and are not meant to be limiting.

FIG. 12 shows a functional diagram of an exemplary communication station 1200, in accordance with one or more example embodiments of the present disclosure. In one embodiment, FIG. 12 illustrates a functional block diagram of a communication station that may be suitable for use as an AP 102 (FIG. 1) or a user device 120 (FIG. 1) in accordance with some embodiments. The communication station 1200 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1200 may include communications circuitry 1202 and a transceiver 1210 for transmitting and receiving signals to and from other communication stations using one or more antennas 1201. The communications circuitry 1202 may include circuitry that can operate the physical layer (PHY) communications and/or medium access control (MAC) communications for controlling access to the wireless medium, and/or any other communications layers for transmitting and receiving signals. The communication station 1200 may also include processing circuitry 1206 and memory 1208 arranged to perform the operations described herein. In some embodiments, the communications circuitry 1202 and the processing circuitry 1206 may be configured to perform operations detailed in the above figures, diagrams, and flows.

In accordance with some embodiments, the communications circuitry 1202 may be arranged to contend for a wireless medium and configure frames or packets for communicating over the wireless medium. The communications circuitry 1202 may be arranged to transmit and receive signals. The communications circuitry 1202 may also include circuitry for modulation/demodulation, upconversion/downconversion, filtering, amplification, etc. In some embodiments, the processing circuitry 1206 of the communication station 1200 may include one or more processors. In other embodiments, two or more antennas 1201 may be coupled to the communications circuitry 1202 arranged for sending and receiving signals. The memory 1208 may store information for configuring the processing circuitry 1206 to perform operations for configuring and transmitting message frames and performing the various operations described herein. The memory 1208 may include any type of memory, including non-transitory memory, for storing information in a form readable by a machine (e.g., a computer). For example, the memory 1208 may include a computer-readable storage device, read-only memory (ROM), random-access memory (RAM), magnetic disk storage media, optical storage media, flash-memory devices and other storage devices and media.

In some embodiments, the communication station 1200 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1200 may include one or more antennas 1201. The antennas 1201 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1200 may include one or more of a keyboard, a display, a non-volatile memory port, multiple antennas, a graphics processor, an application processor, speakers, and other mobile device elements. The display may be an LCD screen including a touch screen.

Although the communication station 1200 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1200 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1200 may include one or more processors and may be configured with instructions stored on a computer-readable storage device.

FIG. 13 illustrates a block diagram of an example of a machine 1300 or system upon which any one or more of the techniques (e.g., methodologies) discussed herein may be performed. In other embodiments, the machine 1300 may operate as a standalone device or may be connected (e.g., networked) to other machines. In a networked deployment, the machine 1300 may operate in the capacity of a server machine, a client machine, or both in server-client network environments. In an example, the machine 1300 may act as a peer machine in peer-to-peer (P2P) (or other distributed) network environments. The machine 1300 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number o components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1300 may include a hardware processor 1302 (e.g., a central processing unit (CPU), a graphics processing unit (GPU), a hardware processor core, or any combination thereof), a main memory 1304 and a static memory 1306, some or all of which may communicate with each other via an interlink (e.g., bus) 1308. The machine 1300 may further include a power management device 1332, a graphics display device 1310, an alphanumeric input device 1312 (e.g., a keyboard), and a user interface (UI) navigation device 1314 (e.g., a mouse). In an example, the graphics display device 1310, alphanumeric input device 1312, and UI navigation device 1314 may be a touch screen display. The machine 1300 may additionally include a storage device (i.e., drive unit) 1316, a signal generation device 1318 (e.g., a speaker), a optimized beamforming exchange device 1319, a network interface device/transceiver 1320 coupled to antenna(s) 1330, and one or more sensors 1328, such as a global positioning system (GPS) sensor, a compass, an accelerometer, or other sensor. The machine 1300 may include an output controller 1334, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1302 for generation and processing of the baseband signals and for controlling operations of the main memory 1304, the storage device 1316, and/or the optimized beamforming exchange device 1319. The baseband processor may be provided on a single radio card, a single chip, or an integrated circuit (IC).

The storage device 1316 may include a machine readable medium 1322 on which is stored one or more sets of data structures or instructions 1324 (e.g., software) embodying or utilized by any one or more of the techniques or functions described herein. The instructions 1324 may also reside, completely or at least partially, within the main memory 1304, within the static memory 1306, or within the hardware processor 1302 during execution thereof by the machine 1300. In an example, one or any combination of the hardware processor 1302, the main memory 1304, the static memory 1306, or the storage device 1316 may constitute machine-readable media.

The optimized beamforming exchange device 1319 may carry out or perform any of the operations and processes (e.g., process 1100) described and shown above.

It is understood that the above are only a subset of what the optimized beamforming exchange device 1319 may be configured to perform and that other functions included throughout this disclosure may also be performed by the optimized beamforming exchange device 1319.

While the machine-readable medium 1322 is illustrated as a single medium, the term “machine-readable medium” may include a single medium or multiple media (e.g., a centralized or distributed database, and/or associated caches and servers) configured to store the one or more instructions 1324.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1300 and that cause the machine 1300 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1324 may further be transmitted or received over a communications network 1326 using a transmission medium via the network interface device/transceiver 1320 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1320 may include one or more physical jacks (e.g., Ethernet, coaxial, or phone jacks) or one or more antennas to connect to the communications network 1326. In an example, the network interface device/transceiver 1320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1300 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

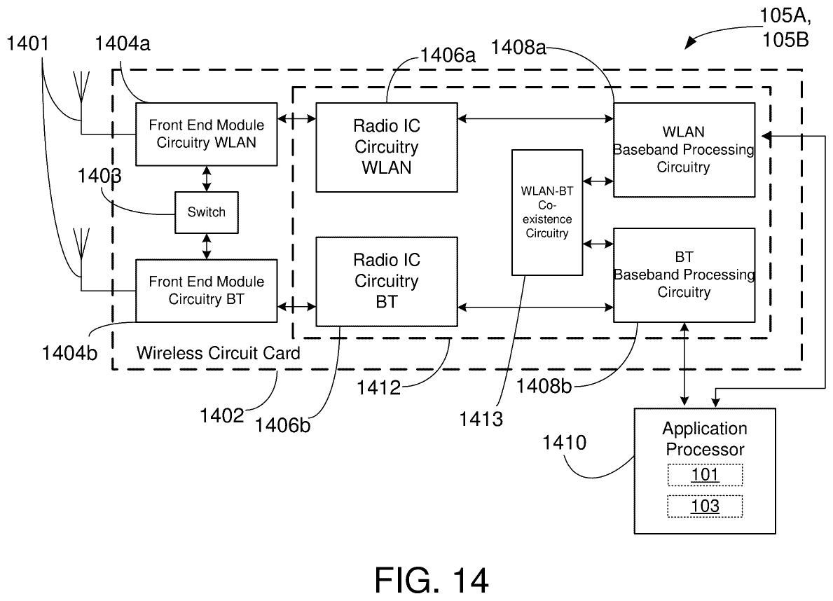

FIG. 14 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1404a-b, radio IC circuitry 1406a-b and baseband processing circuitry 1408a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1404a-b may include a WLAN or Wi-Fi FEM circuitry 1404a and a Bluetooth (BT) FEM circuitry 1404b. The WLAN FEM circuitry 1404a may include a receive signal path comprising circuitry configured to operate on WLAN RF signals received from one or more antennas 1401, to amplify the received signals and to provide the amplified versions of the received signals to the WLAN radio IC circuitry 1406a for further processing. The BT FEM circuitry 1404b may include a receive signal path which may include circuitry configured to operate on BT RF signals received from one or more antennas 1401, to amplify the received signals and to provide the amplified versions of the received signals to the BT radio IC circuitry 1406b for further processing. FEM circuitry 1404a may also include a transmit signal path which may include circuitry configured to amplify WLAN signals provided by the radio IC circuitry 1406a for wireless transmission by one or more of the antennas 1401. In addition, FEM circuitry 1404b may also include a transmit signal path which may include circuitry configured to amplify BT signals provided by the radio IC circuitry 1406b for wireless transmission by the one or more antennas. In the embodiment of FIG. 14, although FEM 1404a and FEM 1404b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1406a-b as shown may include WLAN radio IC circuitry 1406a and BT radio IC circuitry 1406b. The WLAN radio IC circuitry 1406a may include a receive signal path which may include circuitry to down-convert WLAN RF signals received from the FEM circuitry 1404a and provide baseband signals to WLAN baseband processing circuitry 1408a. BT radio IC circuitry 1406b may in turn include a receive signal path which may include circuitry to down-convert BT RF signals received from the FEM circuitry 1404b and provide baseband signals to BT baseband processing circuitry 1408b. WLAN radio IC circuitry 1406a may also include a transmit signal path which may include circuitry to up-convert WLAN baseband signals provided by the WLAN baseband processing circuitry 1408a and provide WLAN RF output signals to the FEM circuitry 1404a for subsequent wireless transmission by the one or more antennas 1401. BT radio IC circuitry 1406b may also include a transmit signal path which may include circuitry to up-convert BT baseband signals provided by the BT baseband processing circuitry 1408b and provide BT RF output signals to the FEM circuitry 1404b for subsequent wireless transmission by the one or more antennas 1401. In the embodiment of FIG. 14, although radio IC circuitries 1406a and 1406b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 1408a-b may include a WLAN baseband processing circuitry 1408a and a BT baseband processing circuitry 1408b. The WLAN baseband processing circuitry 1408a may include a memory, such as, for example, a set of RAM arrays in a Fast Fourier Transform or Inverse Fast Fourier Transform block (not shown) of the WLAN baseband processing circuitry 1408a. Each of the WLAN baseband circuitry 1408a and the BT baseband circuitry 1408b may further include one or more processors and control logic to process the signals received from the corresponding WLAN or BT receive signal path of the radio IC circuitry 1406a-b, and to also generate corresponding WLAN or BT baseband signals for the transmit signal path of the radio IC circuitry 1406a-b. Each of the baseband processing circuitries 1408a and 1408b may further include physical layer (PHY) and medium access control layer (MAC) circuitry, and may further interface with a device for generation and processing of the baseband signals and for controlling operations of the radio IC circuitry 1406a-b.

Referring still to FIG. 14, according to the shown embodiment, WLAN-BT coexistence circuitry 1413 may include logic providing an interface between the WLAN baseband circuitry 1408a and the BT baseband circuitry 1408b to enable use cases requiring WLAN and BT coexistence. In addition, a switch 1403 may be provided between the WLAN FEM circuitry 1404a and the BT FEM circuitry 1404b to allow switching between the WLAN and BT radios according to application needs. In addition, although the antennas 1401 are depicted as being respectively connected to the WLAN FEM circuitry 1404a and the BT FEM circuitry 1404b, embodiments include within their scope the sharing of one or more antennas as between the WLAN and BT FEMs, or the provision of more than one antenna connected to each of FEM 1404a or 1404b.

In some embodiments, the front-end module circuitry 1404a-b, the radio IC circuitry 1406a-b, and baseband processing circuitry 1408a-b may be provided on a single radio card, such as wireless radio card 1402. In some other embodiments, the one or more antennas 1401, the FEM circuitry 1404a-b and the radio IC circuitry 1406a-b may be provided on a single radio card. In some other embodiments, the radio IC circuitry 1406a-b and the baseband processing circuitry 1408a-b may be provided on a single chip or integrated circuit (IC), such as IC 1412.

In some embodiments, the wireless radio card 1402 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 14, the BT baseband circuitry 1408b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

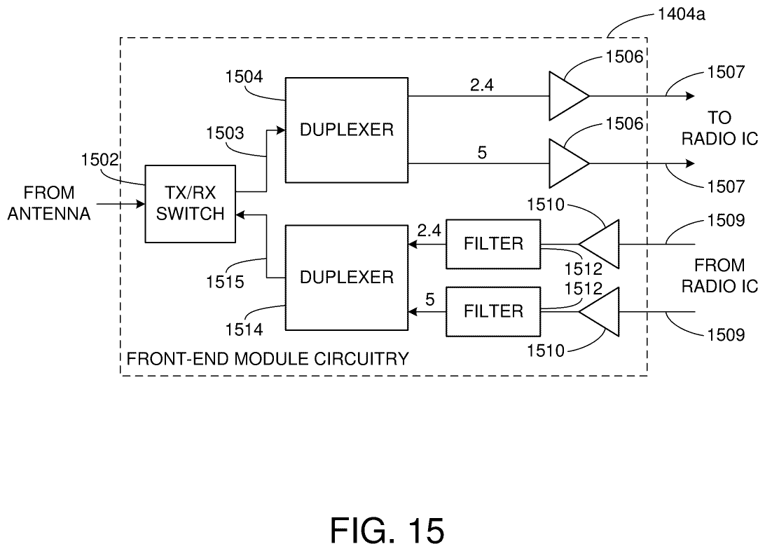

FIG. 15 illustrates WLAN FEM circuitry 1404a in accordance with some embodiments. Although the example of FIG. 15 is described in conjunction with the WLAN FEM circuitry 1404a, the example of FIG. 15 may be described in conjunction with the example BT FEM circuitry 1404b (FIG. 14), although other circuitry configurations may also be suitable.

In some embodiments, the FEM circuitry 1404a may include a TX/RX switch 1502 to switch between transmit mode and receive mode operation. The FEM circuitry 1404a may include a receive signal path and a transmit signal path. The receive signal path of the FEM circuitry 1404a may include a low-noise amplifier (LNA) 1506 to amplify received RF signals 1503 and provide the amplified received RF signals 1507 as an output (e.g., to the radio IC circuitry 1406a-b (FIG. 14)). The transmit signal path of the circuitry 1404a may include a power amplifier (PA) to amplify input RF signals 1509 (e.g., provided by the radio IC circuitry 1406a-b), and one or more filters 1512, such as band-pass filters (BPFs), low-pass filters (LPFs) or other types of filters, to generate RF signals 1515 for subsequent transmission (e.g., by one or more of the antennas 1401 (FIG. 14)) via an example duplexer 1514.

In some dual-mode embodiments for Wi-Fi communication, the FEM circuitry 1404a may be configured to operate in either the 2.4 GHz frequency spectrum or the 5 GHz frequency spectrum. In these embodiments, the receive signal path of the FEM circuitry 1404a may include a receive signal path duplexer 1504 to separate the signals from each spectrum as well as provide a separate LNA 1506 for each spectrum as shown. In these embodiments, the transmit signal path of the FEM circuitry 1404a may also include a power amplifier 1510 and a filter 1512, such as a BPF, an LPF or another type of filter for each frequency spectrum and a transmit signal path duplexer 1504 to provide the signals of one of the different spectrums onto a single transmit path for subsequent transmission by the one or more of the antennas 1401 (FIG. 14). In some embodiments, BT communications may utilize the 2.4 GHz signal paths and may utilize the same FEM circuitry 1404a as the one used for WLAN communications.

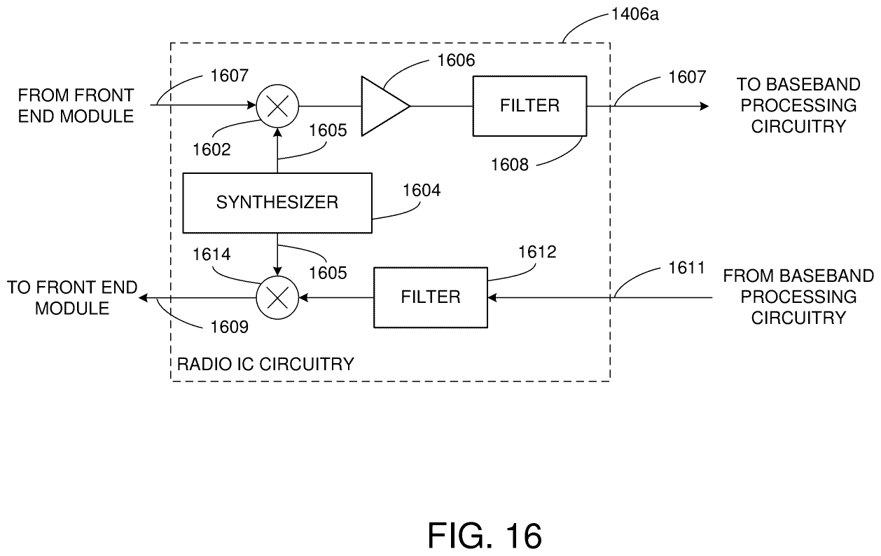

FIG. 16 illustrates radio IC circuitry 1406a in accordance with some embodiments. The radio IC circuitry 1406a is one example of circuitry that may be suitable for use as the WLAN or BT radio IC circuitry 1406a/1406b (FIG. 14), although other circuitry configurations may also be suitable. Alternatively, the example of FIG. 16 may be described in conjunction with the example BT radio IC circuitry 1406b.

In some embodiments, the radio IC circuitry 1406a may include a receive signal path and a transmit signal path. The receive signal path of the radio IC circuitry 1406a may include at least mixer circuitry 1602, such as, for example, down-conversion mixer circuitry, amplifier circuitry 1606 and filter circuitry 1608. The transmit signal path of the radio IC circuitry 1406a may include at least filter circuitry 1612 and mixer circuitry 1614, such as, for example, up-conversion mixer circuitry. Radio IC circuitry 1406a may also include synthesizer circuitry 1604 for synthesizing a frequency 1605 for use by the mixer circuitry 1602 and the mixer circuitry 1614. The mixer circuitry 1602 and/or 1614 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 16 illustrates only a simplified version of a radio IC circuitry, and may include, although not shown, embodiments where each of the depicted circuitries may include more than one component. For instance, mixer circuitry 1614 may each include one or more mixers, and filter circuitries 1608 and/or 1612 may each include one or more filters, such as one or more BPFs and/or LPFs according to application needs. For example, when mixer circuitries are of the direct-conversion type, they may each include two or more mixers.

In some embodiments, mixer circuitry 1602 may be configured to down-convert RF signals 1507 received from the FEM circuitry 1404a-b (FIG. 14) based on the synthesized frequency 1605 provided by synthesizer circuitry 1604. The amplifier circuitry 1606 may be configured to amplify the down-converted signals and the filter circuitry 1608 may include an LPF configured to remove unwanted signals from the down-converted signals to generate output baseband signals 1607. Output baseband signals 1607 may be provided to the baseband processing circuitry 1408a-b (FIG. 14) for further processing. In some embodiments, the output baseband signals 1607 may be zero-frequency baseband signals, although this is not a requirement. In some embodiments, mixer circuitry 1602 may comprise passive mixers, although the scope of the embodiments is not limited in this respect.

In some embodiments, the mixer circuitry 1614 may be configured to up-convert input baseband signals 1611 based on the synthesized frequency 1605 provided by the synthesizer circuitry 1604 to generate RF output signals 1509 for the FEM circuitry 1404a-b. The baseband signals 1611 may be provided by the baseband processing circuitry 1408a-b and may be filtered by filter circuitry 1612. The filter circuitry 1612 may include an LPF or a BPF, although the scope of the embodiments is not limited in this respect.

In some embodiments, the mixer circuitry 1602 and the mixer circuitry 1614 may each include two or more mixers and may be arranged for quadrature down-conversion and/or up-conversion respectively with the help of synthesizer 1604. In some embodiments, the mixer circuitry 1602 and the mixer circuitry 1614 may each include two or more mixers each configured for image rejection (e.g., Hartley image rejection). In some embodiments, the mixer circuitry 1602 and the mixer circuitry 1614 may be arranged for direct down-conversion and/or direct up-conversion, respectively. In some embodiments, the mixer circuitry 1602 and the mixer circuitry 1614 may be configured for super-heterodyne operation, although this is not a requirement.

Mixer circuitry 1602 may comprise, according to one embodiment: quadrature passive mixers (e.g., for the in-phase (I) and quadrature phase (Q) paths). In such an embodiment, RF input signal 1507 from FIG. 16 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1605 of synthesizer 1604 (FIG. 16). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction in power consumption.

The RF input signal 1507 (FIG. 15) may comprise a balanced signal, although the scope of the embodiments is not limited in this respect. The I and Q baseband output signals may be provided to low-noise amplifier, such as amplifier circuitry 1606 (FIG. 16) or to filter circuitry 1608 (FIG. 16).

In some embodiments, the output baseband signals 1607 and the input baseband signals 1611 may be analog baseband signals, although the scope of the embodiments is not limited in this respect. In some alternate embodiments, the output baseband signals 1607 and the input baseband signals 1611 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1604 may be a fractional-N synthesizer or a fractional N/N+1 synthesizer, although the scope of the embodiments is not limited in this respect as other types of frequency synthesizers may be suitable. For example, synthesizer circuitry 1604 may be a delta-sigma synthesizer, a frequency multiplier, or a synthesizer comprising a phase-locked loop with a frequency divider. According to some embodiments, the synthesizer circuitry 1604 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 1604 may be provided by a voltage controlled oscillator (VCO), although that is not a requirement. A divider control input may further be provided by either the baseband processing circuitry 1408a-b (FIG. 14) depending on the desired output frequency 1605. In some embodiments, a divider control input (e.g., N) may be determined from a look-up table (e.g., within a Wi-Fi card) based on a channel number and a channel center frequency as determined or indicated by the example application processor 1410. The application processor 1410 may include, or otherwise be connected to, one of the example secure signal converter 101 or the example received signal converter 103 (e.g., depending on which device the example radio architecture is implemented in).

In some embodiments, synthesizer circuitry 1604 may be configured to generate a carrier frequency as the output frequency 1605, while in other embodiments, the output frequency 1605 may be a fraction of the carrier frequency (e.g., one-half the carrier frequency, one-third the carrier frequency). In some embodiments, the output frequency 1605 may be a LO frequency (fLO).

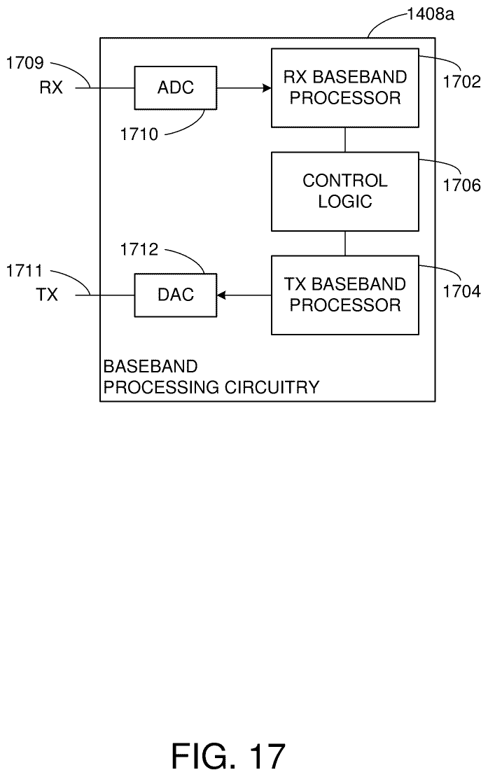

FIG. 17 illustrates a functional block diagram of baseband processing circuitry 1408a in accordance with some embodiments. The baseband processing circuitry 1408a is one example of circuitry that may be suitable for use as the baseband processing circuitry 1408a (FIG. 14), although other circuitry configurations may also be suitable. Alternatively, the example of FIG. 16 may be used to implement the example BT baseband processing circuitry 1408b of FIG. 14.

The baseband processing circuitry 1408a may include a receive baseband processor (RX BBP) 1702 for processing receive baseband signals 1609 provided by the radio IC circuitry 1406a-b (FIG. 14) and a transmit baseband processor (TX BBP) 1704 for generating transmit baseband signals 1611 for the radio IC circuitry 1406a-b. The baseband processing circuitry 1408a may also include control logic 1706 for coordinating the operations of the baseband processing circuitry 1408a.

In some embodiments (e.g., when analog baseband signals are exchanged between the baseband processing circuitry 1408a-b and the radio IC circuitry 1406a-b), the baseband processing circuitry 1408a may include ADC 1710 to convert analog baseband signals 1709 received from the radio IC circuitry 1406a-b to digital baseband signals for processing by the RX BBP 1702. In these embodiments, the baseband processing circuitry 1408a may also include DAC 1712 to convert digital baseband signals from the TX BBP 1704 to analog baseband signals 1711.

In some embodiments that communicate OFDM signals or OFDMA signals, such as through baseband processor 1408a, the transmit baseband processor 1704 may be configured to generate OFDM or OFDMA signals as appropriate for transmission by performing an inverse fast Fourier transform (IFFT). The receive baseband processor 1702 may be configured to process received OFDM signals or OFDMA signals by performing an FFT. In some embodiments, the receive baseband processor 1702 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 14, in some embodiments, the antennas 1401 (FIG. 14) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1401 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: transmit a coordinated beamforming (Co-BF) invite frame comprising a first Ack Sequence Duration; receive from a coordinated AP a Co-BF response frame comprising a Co-BF status code and a second Ack Sequence Duration; transmit a data PPDU comprising MPDUs having an Ack policy set to either HETP Ack or Block Ack based on the Co-BF Response frame; and perform a sequential acknowledgment procedure first to solicit receiving status of MSDUs or A-MSDUs from recipient non-AP STAs based on the data PPDU.

Example 2 may include the device of example 1 and/or some other example(s) herein, wherein the processing circuitry may be further configured to determine that the Co-BF Status Code indicates SUCCESS.

Example 3 may include the device of example 1 and/or some other example(s) herein, wherein the processing circuitry may be further configured to determine that the Co-BF Status Code indicates REJECTED_REASON_UNSPECIFIED and to forego transmitting the data PPDU.

Example 4 may include the device of example 1 and/or some other example(s)herein, wherein the processing circuitry may be further configured to set the Ack policy to HETP Ack.

Example 5 may include the device of example 6 and/or some other example(s) herein, wherein the processing circuitry may be further configured to transmit a Co-BF Trigger frame in a non-HT PPDU format or a non-HT duplicate PPDU format using a rate of 6 Mb/s, 12 Mb/s, or 24 Mb/s.

Example 6 may include the device of example 1 and/or some other example(s) herein, wherein the processing circuitry may be further configured to compare the first Ack Sequence Duration in the Co-BF Invite frame with the second Ack Sequence Duration in the Co-BF Response frame.

Example 7 may include the device of example 1 and/or some other example(s) herein, wherein a receiver address of the Co-BF Invite frame may be a MAC address of the coordinated AP.

Example 8 may include the device of example 1 and/or some other example(s) herein, wherein a receiver address of the Co-BF response frame may be a MAC address of the coordinating AP.

Example 9 may include the device of example 1 and/or some other example(s) herein, wherein a MAC frame type of the Co-BF response frame may be Multi-STA BlockAck.

Example 10 may include a non-transitory computer-readable medium storing computer-executable instructions which when executed by one or more processors result in performing operations comprising: transmitting a coordinated beamforming (Co-BF) invite frame comprising a first Ack Sequence Duration; receiving from a coordinated AP a Co-BF response frame comprising a Co-BF status code and a second Ack Sequence Duration; transmitting a data PPDU comprising MPDUs having an Ack policy set to either HETP Ack or Block Ack based on the Co-BF Response frame; and performing a sequential acknowledgment procedure first to solicit receiving status of MSDUs or A-MSDUs from recipient non-AP STAs based on the data PPDU.

Example 11 may include the non-transitory computer-readable medium of example 10 and/or some other example(s) herein, wherein the operations further comprise determining that the Co-BF Status Code indicates SUCCESS.

Example 12 may include the non-transitory computer-readable medium of example 10 and/or some other example(s) herein, wherein the operations further comprise determining that the Co-BF Status Code indicates REJECTED_REASON_UNSPECIFIED and to forego transmitting the data PPDU.

Example 13 may include the non-transitory computer-readable medium of example 10 and/or some other example(s) herein, wherein the operations further comprise setting the Ack policy to HETP Ack.

Example 14 may include the non-transitory computer-readable medium of example 15 and/or some other example(s) herein, wherein the operations further comprise transmitting a Co-BF Trigger frame in a non-HT PPDU format or a non-HT duplicate PPDU format using a rate of 6 Mb/s, 12 Mb/s, or 24 Mb/s.

Example 15 may include the non-transitory computer-readable medium of example 10 and/or some other example(s) herein, wherein the operations further comprise comparing the first Ack Sequence Duration in the Co-BF Invite frame with the second Ack Sequence Duration in the Co-BF Response frame.

Example 16 may include the non-transitory computer-readable medium of example 10 and/or some other example(s) herein, wherein a receiver address of the Co-BF Invite frame may be a MAC address of the coordinated AP.

Example 17 may include the non-transitory computer-readable medium of example 10 and/or some other example(s) herein, wherein a receiver address of the Co-BF response frame may be a MAC address of the coordinating AP.

Example 18 may include the non-transitory computer-readable medium of example 10 and/or some other example(s) herein, wherein a MAC frame type of the Co-BF response frame may be Multi-STA BlockAck.

Example 19 may include a method comprising: transmitting a coordinated beamforming (Co-BF) invite frame comprising a first Ack Sequence Duration; receiving from a coordinated AP a Co-BF response frame comprising a Co-BF status code and a second Ack Sequence Duration; transmitting a data PPDU comprising MPDUs having an Ack policy set to either HETP Ack or Block Ack based on the Co-BF Response frame; and performing a sequential acknowledgment procedure first to solicit receiving status of MSDUs or A-MSDUs from recipient non-AP STAs based on the data PPDU.

Example 20 may include the method of example 19 and/or some other example(s) herein, the method further comprising determining that the Co-BF Status Code indicates SUCCESS.

Example 21 may include the method of example 19 and/or some other example(s) herein, the method further comprising determining that the Co-BF Status Code indicates REJECTED_REASON_UNSPECIFIED and to forego transmitting the data PPDU.

Example 22 may include the method of example 19 and/or some other example(s) herein, the method further comprising setting the Ack policy to HETP Ack.

Example 23 may include the method of example 24 and/or some other example(s) herein, the method further comprising transmitting a Co-BF Trigger frame in a non-HT PPDU format or a non-HT duplicate PPDU format using a rate of 6 Mb/s, 12 Mb/s, or 24 Mb/s.

Example 24 may include the method of example 19 and/or some other example(s) herein, the method further comprising comparing the first Ack Sequence Duration in the Co-BF Invite frame with the second Ack Sequence Duration in the Co-BF Response frame.

Example 25 may include the method of example 19 and/or some other example(s) herein, wherein a receiver address of the Co-BF Invite frame may be a MAC address of the coordinated AP.

Example 26 may include the method of example 19 and/or some other example(s) herein, wherein a receiver address of the Co-BF response frame may be a MAC address of the coordinating AP.

Example 27 may include the method of example 19 and/or some other example(s) herein, wherein a MAC frame type of the Co-BF response frame may be Multi-STA BlockAck.

Example 28 may include an apparatus comprising means for: transmitting a coordinated beamforming (Co-BF) invite frame comprising a first Ack Sequence Duration; receiving from a coordinated AP a Co-BF response frame comprising a Co-BF status code and a second Ack Sequence Duration; transmitting a data PPDU comprising MPDUs having an Ack policy set to either HETP Ack or Block Ack based on the Co-BF Response frame; and performing a sequential acknowledgment procedure first to solicit receiving status of MSDUs or A-MSDUs from recipient non-AP STAs based on the data PPDU.

Example 29 may include the apparatus of example 28 and/or some other example(s) herein, further comprising determining that the Co-BF Status Code indicates SUCCESS.

Example 30 may include the apparatus of example 28 and/or some other example(s) herein, further comprising determining that the Co-BF Status Code indicates REJECTED_REASON_UNSPECIFIED and to forego transmitting the data PPDU.

Example 31 may include the apparatus of example 28 and/or some other example(s) herein, further comprising setting the Ack policy to HETP Ack.

Example 32 may include the apparatus of example 33 and/or some other example(s) herein, further comprising transmitting a Co-BF Trigger frame in a non-HT PPDU format or a non-HT duplicate PPDU format using a rate of 6 Mb/s, 12 Mb/s, or 24 Mb/s.

Example 33 may include the apparatus of example 28 and/or some other example(s) herein, further comprising comparing the first Ack Sequence Duration in the Co-BF Invite frame with the second Ack Sequence Duration in the Co-BF Response frame.

Example 34 may include the apparatus of example 28 and/or some other example(s) herein, wherein a receiver address of the Co-BF Invite frame may be a MAC address of the coordinated AP.

Example 35 may include the apparatus of example 28 and/or some other example(s) herein, wherein a receiver address of the Co-BF response frame may be a MAC address of the coordinating AP.

Example 36 may include the apparatus of example 28 and/or some other example(s) herein, wherein a MAC frame type of the Co-BF response frame may be Multi-STA BlockAck.

Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 38 may include an apparatus comprising logic, modules, and/or circuitry to perform one or more elements of a method described in or related to any of examples 1-36, or any other method or process described herein.

Example 39 may include a method, technique, or process as described in or related to any of examples 1-36, or portions or parts thereof.

Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.

Example 41 may include a method of communicating in a wireless network as shown and described herein.

Example 42 may include a system for providing wireless communication as shown and described herein.

Example 43 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device comprising processing circuitry coupled to storage, the processing circuitry configured to:
transmit a coordinated beamforming (Co-BF) invite frame comprising a first Ack Sequence Duration;
receive from a coordinated AP a Co-BF response frame comprising a Co-BF status code and a second Ack Sequence Duration;
transmit a data PPDU comprising MPDUs having an Ack policy set to either HETP Ack or Block Ack based on the Co-BF Response frame; and
perform a sequential acknowledgment procedure first to solicit receiving status of MSDUs or A-MSDUs from recipient non-AP STAs based on the data PPDU.

2. The device of claim 1, wherein the processing circuitry is further configured to determine that the Co-BF Status Code indicates SUCCESS.

3. The device of claim 1, wherein the processing circuitry is further configured to determine that the Co-BF Status Code indicates REJECTED_REASON_UNSPECIFIED and to forego transmitting the data PPDU.

4. The device of claim 1, wherein the processing circuitry is further configured to set the Ack policy to HETP Ack.

5. The device of claim 4, wherein the processing circuitry is further configured to transmit a Co-BF Trigger frame in a non-HT PPDU format or a non-HT duplicate PPDU format using a rate of 6 Mb/s, 12 Mb/s, or 24 Mb/s.

6. The device of claim 1, wherein the processing circuitry is further configured to compare the first Ack Sequence Duration in the Co-BF Invite frame with the second Ack Sequence Duration in the Co-BF Response frame.

7. The device of claim 1, wherein a receiver address of the Co-BF Invite frame is a MAC address of the coordinated AP.

8. The device of claim 1, wherein a receiver address of the Co-BF response frame is a MAC address of the coordinating AP.

9. The device of claim 1, wherein a MAC frame type of the Co-BF response frame is Multi-STA BlockAck.

10. A non-transitory computer-readable medium storing computer-executable instructions which when executed by one or more processors result in performing operations comprising:
transmitting a coordinated beamforming (Co-BF) invite frame comprising a first Ack Sequence Duration;
receiving from a coordinated AP a Co-BF response frame comprising a Co-BF status code and a second Ack Sequence Duration;
transmitting a data PPDU comprising MPDUs having an Ack policy set to either HETP Ack or Block Ack based on the Co-BF Response frame; and
performing a sequential acknowledgment procedure first to solicit receiving status of MSDUs or A-MSDUs from recipient non-AP STAs based on the data PPDU.

11. The non-transitory computer-readable medium of claim 10, wherein the operations further comprise determining that the Co-BF Status Code indicates SUCCESS.

12. The non-transitory computer-readable medium of claim 10, wherein the operations further comprise determining that the Co-BF Status Code indicates REJECTED_REASON_UNSPECIFIED and to forego transmitting the data PPDU.

13. The non-transitory computer-readable medium of claim 10, wherein the operations further comprise setting the Ack policy to HETP Ack.

14. The non-transitory computer-readable medium of claim 13, wherein the operations further comprise transmitting a Co-BF Trigger frame in a non-HT PPDU format or a non-HT duplicate PPDU format using a rate of 6 Mb/s, 12 Mb/s, or 24 Mb/s.

15. The non-transitory computer-readable medium of claim 10, wherein the operations further comprise comparing the first Ack Sequence Duration in the Co-BF Invite frame with the second Ack Sequence Duration in the Co-BF Response frame.

16. The non-transitory computer-readable medium of claim 10, wherein a receiver address of the Co-BF Invite frame is a MAC address of the coordinated AP.

17. The non-transitory computer-readable medium of claim 10, wherein a receiver address of the Co-BF response frame is a MAC address of the coordinating AP.

18. The non-transitory computer-readable medium of claim 10, wherein a MAC frame type of the Co-BF response frame is Multi-STA BlockAck.

19. A method comprising:
transmitting a coordinated beamforming (Co-BF) invite frame comprising a first Ack Sequence Duration;
receiving from a coordinated AP a Co-BF response frame comprising a Co-BF status code and a second Ack Sequence Duration;
transmitting a data PPDU comprising MPDUs having an Ack policy set to either HETP Ack or Block Ack based on the Co-BF Response frame; and
performing a sequential acknowledgment procedure first to solicit receiving status of MSDUs or A-MSDUs from recipient non-AP STAs based on the data PPDU.

20. The method of claim 19, the method further comprising determining that the Co-BF Status Code indicates SUCCESS.
